(19) United States
(12) Patent Application Publication
(10) Pub. No.: US 2026/0175306 A1
(43) Pub. Date: Jun. 25, 2026

(54) CHARACTERISATION OF A SAW BAND OF A BAND SAW MACHINE

(71) Applicant: Technische Universität Wien, Wien (AT)

(72) Inventors: Florian Hoffer, Wien (AT); Clemens Hohensulz, Wien (AT); Gerhard Wiesinger, Wien (AT); Friedrich Bleicher, Wien (AT)

(21) Appl. No.: 19/127,537

(22) PCT Filed: Oct. 30, 2023
(86) PCT No.: PCT/EP2023/080190

§ 371 Date: May 6, 2025

(30) Foreign Application Priority Data
Nov. 7, 2022 (DE) 102022129385.8

(51) Int. Cl. B23D 55/08; B23D 59/00; B23D 61/12

(52) U.S. Cl. CPC B23D 55/082; B23D 59/001; B23D 59/002; B23D 61/1212

(57) ABSTRACT

This application relates to a measuring device for characterising a saw band (11) of a band saw machine. According to one embodiment, the measuring device has the following: a first inductive distance sensor (30), which is designed to generate a sensor signal that represents a distance between a sensor position and a front side of the saw band (11), on which saw teeth (101, 102) are present; a support roller (32); and a preload mechanism, which is designed to press the roller against a rear side of the saw band (11).

### TECHNICAL FIELD

The present invention relates, inter alia, to a concept for characterizing a saw band of a band saw machine.

### BACKGROUND

A wide variety of band sawing machines are known. Band saw machines with computer-aided numerical control (CNC) are frequently used in industrial environments. The machine control requires various parameters for the correct control of the sawing process, which for many machines have to be manually entered into the machine control by an operator. For this purpose, the machine controls comprise suitable human-machine interfaces (HMI, human-machine interface).

The parameters mentioned relate in particular to the saw band, since its properties have a direct influence on the sawing process. For example, the width of the cutting channel must be taken into account when positioning the workpiece (e.g. automatically or semi-automatically). This in turn depends on the geometry of the saw band and must be manually entered into the machine control in known machines. Furthermore, the permissible cutting speed (and thus the band speed and/or the feed speed) can depend on the type of saw band, for example on any existing setting (setting) of the teeth of the saw band or on the material of the saw teeth (for example high-speed steel or hard metal). Depending on the type of machine, these parameters must also be communicated to the machine control.

As shown above, although the sawing process is automated per se, the correct process control depends on parameters which are manually input into the machine control by an operator (operator), which represents a source of error. There are concepts to help prevent such errors in the configuration of the machine control. For example, saw bands can be physically marked with bar codes, QR codes (Quick Response Code) , RFID tags (Radio-Frequency Identification Tags) or the like. Such marking/coding can be read automatically (optically in the case of bar codes or QR codes or electromagnetically in the case of RFID tags) by means of suitable reading devices. It represents a numerical code for which the corresponding parameters for the machine control can be stored in a database. This concept of marking the saw bands has the problem that different manufacturers use different systems for marking the saw bands, which leads to compatibility problems when using saw bands from different manufacturers. Furthermore, a marking of saw bands by means of bar codes, QR codes, RFID tags, etc. permits an identification of the saw band, but does not permit a determination of the wear state of a saw band, which can also be a parameter relevant for the machine control. Furthermore, markings such as bar codes engraved into the saw band by means of lasers are problematic insofar as these can become unreadable due to wear. Naturally, markings can only represent the properties of new saw bands.

The inventors have set themselves the task of improving the situation described above and of developing an improved concept for the automatic characterization of saw bands.

### SUMMARY

The above-mentioned object is achieved by the measuring device according to claim 1 and the system according to claim 12. Different embodiments and further developments are the subject of the dependent claims. In the following, a measuring device for characterizing a saw band of a band sawing machine is described. According to an exemplary embodiment, the measuring device has the following: a first inductive distance sensor, which is designed to generate a sensor signal, which represents a distance between a sensor position and a front side of the saw band, on which saw teeth are present; a support roller; and a preload mechanism, which is designed to press the roller against a rear side of the saw band.

A further exemplary embodiment relates to a system comprising a band saw machine having a saw band and a machine control which is designed to control the operation of the band saw, for which purpose one or more saw band parameters stored in the machine control are used. The system further comprises a measuring device, which is designed to determine at least one parameter value, which characterizes the saw band, wherein the machine control is further designed to receive the parameter value determined with the aid of the measuring device and to store it as a saw band parameter.

### BRIEF DESCRIPTION OF THE DRAWINGS

In the following, the invention will be elucidated in greater detail with reference to examples illustrated in the figures. The illustrations are not necessarily to scale, and the invention is not limited to the illustrated aspects. Instead, focus is placed on representing the principles on which the invention is based. A brief description of the figures is provided in the following:

FIG. 1 schematically shows an example of a CNC band saw machine known per se.

FIG. 2 is an exemplary representation of a saw band (band saw blade) with a broken saw tooth.

FIG. 3 illustrates, based on a schematic sketch, an example of a measurement setup for the automatic detection of defective saw teeth by means of an inductive distance or proximity sensor.

FIG. 4 is a cross-sectional view of FIG. 3.

FIG. 5 illustrates by way of example a possible geometry of a saw tooth (diagram (a)) and various types of setting of the saw teeth (diagrams (b) and (c)).

FIG. 6 illustrates by way of example a modification of the measurement setup of FIG. 3 and FIG. 4.

FIG. 7 shows by way of example a signal curve of the sensor signal of the inductive sensor of FIG. 4 and the detection based thereon of broken or worn saw teeth (diagram (a)) as well as a signal curve of the additional sensor signal of the inductive sensor of FIG. 6 (diagram (b)) and the detection based thereon of the tooth types.

FIG. 8 illustrates a further measurement setup for measuring the width of the cutting channel of a saw band by means of capacitive sensors.

FIG. 9 shows an example of the integration of the measurement setup of FIGS. 3, 4 and 6 into a sensor device.

FIG. 10 is a block diagram for illustrating the coupling of the sensor device according to FIG. 9 with the machine control of the band saw.

FIG. 11 shows a further example of the integration of the measurement setup of FIGS. 3, 4 and 6 into a sensor device.

FIG. 12 shows an example of a method carried out with the aid of the system of FIG. 10 by means of a flowchart.

### DETAILED DESCRIPTION

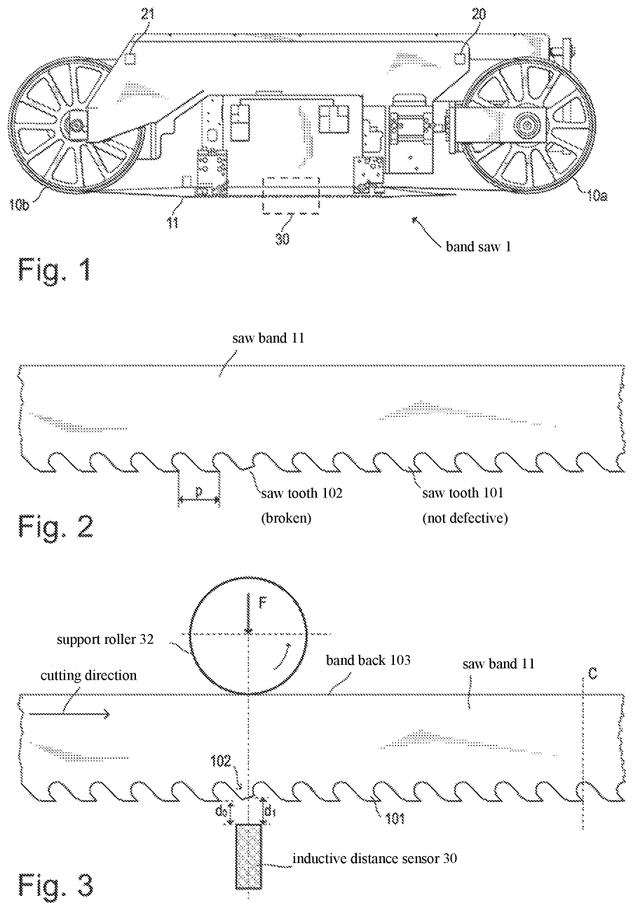

Before various exemplary embodiments are explained in more detail, the general construction of a band saw is briefly illustrated with reference to FIG. 1. It is understood that the exemplary embodiments described here can be used in different types of band saws and their use is not limited to the band saw type shown in FIG. 1.

According to FIG. 1, the band saw 1 has a saw frame (housing) and two running wheels 10a and 10b mounted thereon, one of which is driven by means of an electric motor. The saw band 11 is held by the running wheels and guided by them (similar to a belt). The driven wheel also drives the saw band (with adjustable rotational speed). The other wheel runs along. FIG. 1 also schematically shows a workpiece 30 which is to be cut with the aid of the saw band 11. In the example shown, the cutting plane is vertical. However, there are also band saws with a horizontal or oblique cutting plane.

The numerals 20 and 21 designate those positions on the saw frame (housing) of the band saw 1 at which the measuring device, which will be described in detail later, can be arranged. Mounting the measuring device at these positions is not absolutely necessary, but is nevertheless useful in most applications, since these locations are, in addition to the wheels, comparatively well protected against cooling lubricant (KSS), dirt, chips, dust and other impairments.

The machine control can be arranged in a separate housing and is not shown in FIG. 1. For example, the machine control can be implemented in an industrial PC by means of software. Various types of machine control are known per se and are therefore not discussed in more detail here.

FIG. 2 shows an example of a saw band 11 with a plurality of saw teeth 101. The distance between two adjacent saw teeth is referred to as pitch p. (pitch). When sawing metallic materials in industrial high-performance production, a variable tooth pitch has proven effective in this case. This is usually expressed in teeth per inch. In the example shown in FIG. 2, the saw tooth 102 is broken. For example, a saw tooth can break if a process parameter of the sawing process (e.g. the cutting speed or the feed speed) is set incorrectly. As a result of wear, a saw tooth can also be worn to such an extent that the height of the saw tooth is significantly lower than in the case of an unworn tooth.

The exemplary embodiments described here relate to a concept for characterizing a saw band (band saw blade), wherein in particular the state of wear of the saw band is to be determined, for which purpose defective (broken) saw teeth are to be detected automatically. Some embodiments also permit the detection of the setting of the saw band and/or the measurement of the actual width of the cutting channel. In particular, the state of wear cannot be determined with known methods, such as, for example, with the above-mentioned marking by means of QR codes or the like.

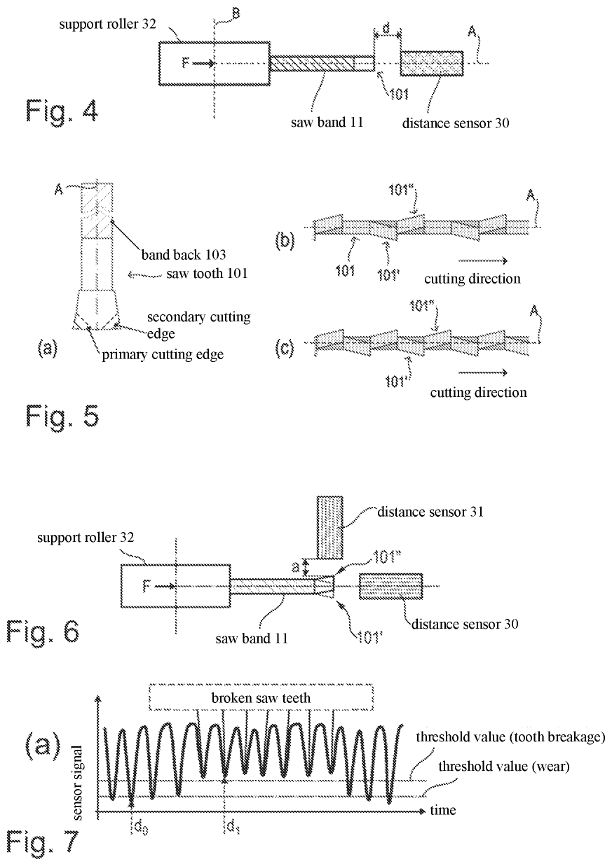

FIG. 3 illustrates a simplified example of a measurement setup for detecting worn (broken) saw teeth with the aid of an inductive sensor. An inductive sensor has proven to be particularly reliable (especially in comparison to optical sensor principles). Suitable sensors are commercially available as inductive distance sensors (position sensors) or proximity sensors (proximity sensors). According to FIG. 3, the inductive sensor 30 lies in the band plane A of the saw band (see also FIG. 4) and monitors the tooth side (narrow side) of the saw band on which the saw teeth are arranged. The measuring direction of the sensor (in which a distance between sensor 30 and saw band 11 is measured) runs in band plane A at right angles to the running direction of the band.

The distance between the sensor 30 and the tip of a saw tooth is denoted by d₀ in FIG. 3. The distance d₀ is the minimum distance between the sensor 30 and the saw band 11. The sensor measures the distance d₀ when it is located directly opposite the tooth tip (main cutting edge) of an unworn saw tooth 101. If the gap between two saw teeth is located opposite the sensor 30, the measured distance d will be greater (d>d₀) . Even if a defective (worn or broken) saw tooth (denoted 102 in FIG. 3) is located opposite the sensor 30, the measured distance d₁ will be greater than the minimum distance d₀ (d₁>d₀).

An inductive distance sensor alone is not sufficient for reliable detection of defective saw teeth. In practice, the saw band 11 not only moves in the running or cutting direction (indicated by the arrow in FIG. 3), but also movements (fluttering) which oscillate transversely to the running direction can occur, which prevent or at least impair a reliable measurement of the distance or a reliable detection of a change in distance. These oscillations can be reduced at least locally in the region of the sensor 30 by arranging a support roller 32 on the band back 103 on the side of the saw band 11 opposite the sensor 30. The support roller 32 can be mounted on a frame structure of the sensor device in such a way that it contacts the narrow side of the band back 102. As soon as the saw band 11 moves, the support roller rotates with it.

The bearing point of the support roller 32 can be displaceable, for example, and can be coupled to a spring in such a way that the support roller 32 is pressed against the back of the band with a force F (preload force). Only the preload force F is important, but not the manner in which it is generated. Therefore, only the preload force F is shown in FIG. 3, but not the spring. The support roller 32 can be made of metal, but in some embodiments also of plastic. The running surface of the support roller 32 can also have a coating of plastic or rubber. In particular in conjunction with the preload force F, the support roller 32 reduces oscillating movements of the saw band 11 transversely to the running direction of the saw band and markedly increases the reliability of the detection of defective saw teeth.

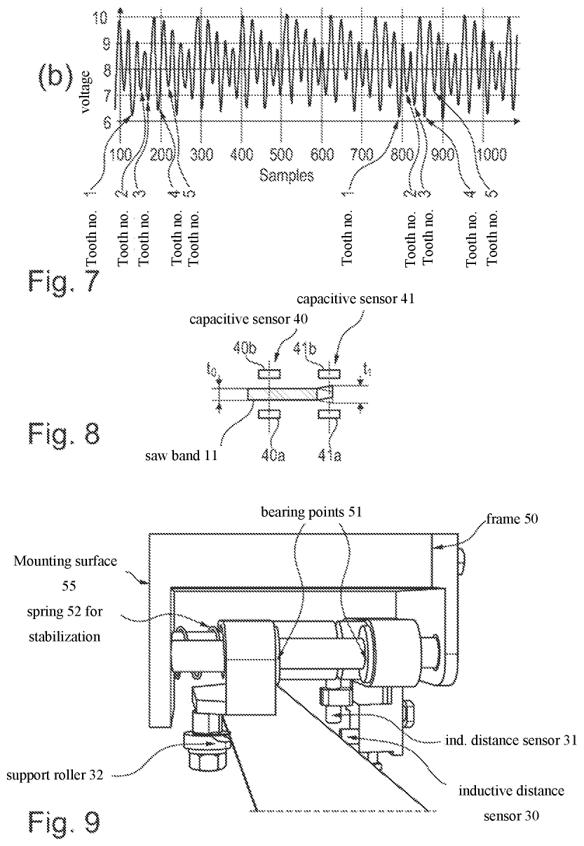

FIG. 4 shows a cross-sectional representation of the example of FIG. 3. The sectional plane C (see FIG. 3) is at a right angle to the running direction of the saw band 11 and runs through the tip of an unworn tooth 101. The axis of rotation B of the support roller 32 is also shown in FIG. 4. The detection of individual broken teeth will be described in more detail later (see also FIG. 7, for example).

FIG. 5 relates to various aspects of the geometry of a saw band and its saw teeth. FIG. 5, diagram (a), shows an example of a special saw tooth geometry, in which the width (thickness) of the saw tooth increases towards the tip, by means of a cross-sectional representation. Such a saw tooth is therefore also referred to as a trapezoidal tooth. The plane A denotes the center plane of the band saw blade. The outermost edge of a saw tooth (normal to the center plane A) forms the main cutting edge. The edge is slanted to the left and right of the center plane. The oblique parts of the cutting edge are also called secondary cutting edges. The part of the saw tooth 101 opposite the main cutting edge has the same thickness as the band back 103. The main and secondary cutting edges of the saw tooth can be made of a different material than the back of the band. For example, the cutting edges can be made of hard metal or high-speed steel, while the band back can be made of normal tool steel. There are saw bands in which saw teeth of different geometry are present. These saw teeth differ, for example, in the width of the main cutting edge. FIG. 5 diagram (a) exemplarily illustrates two possible modifications of the tooth geometry by means of dashed lines. In one case, the main cutting edge extends over the full width of the tooth. In this case, there is practically no secondary cutting edge. In a saw band, saw teeth of different types can follow one another. This is particularly the case with non-crossed saw bands. Groups with a certain sequence of saw teeth can be repeated periodically in a saw band (e.g. tooth 1 with a narrow main cutting edge, tooth 2 with a medium main cutting edge, tooth 3 with a wide main cutting edge).

The diagrams (b) and (c) of FIG. 5 show different types of setting of the saw teeth of a band saw blade. FIG. 5, diagram (b), shows a standard setting in which of three adjacent teeth one is straight (i.e. in the band plane A), one is bent to the left and one is bent to the right (i.e. is inclined with respect to the band plane A). In FIG. 5, diagram (b), the straight saw tooth is designated 101, the saw tooth bent to the right is designated 101′ and the saw tooth bent to the left is designated 101″.

FIG. 5, diagram (c), shows a right-left setting in which the teeth are bent alternately to the right and left. Saw teeth 101 which lie in the band plane A do not exist in this variant. There are also other types of setting, such as group setting, in which groups of two or more consecutive teeth are bent in the same direction, in each case. In the case of a wavy setting, the angle of inclination of the saw teeth varies from tooth to tooth in a periodic manner, it being possible for a period to comprise, for example, eight teeth. Saw bands with hard metal cutting edges often have no setting, whereas bimetallic bands with cutting edges made of high-speed steel almost always have a setting. Various types of band saw blades and various types of settings are known per se and are therefore not discussed further here.

FIG. 6 illustrates an example of a modification/extension of the measurement setup of FIGS. 3 and 4, in which a second inductive position or distance sensor 31 is used to determine the type of setting of the saw band 11. The support roller 32 and the first sensor 30 are arranged in FIG. 6 identically to those in FIGS. 3 and 4 and reference is made to the above description. The sensor 31 has a measuring direction which is at right angles to the band plane A. The sensor 31 accordingly detects the saw band 11 (in particular the saw teeth) from the side. The sensor signal depends on the distance a between the sensor 31 and the saw band (see FIG. 6), the distance a being smaller if the saw tooth located next to the sensor 31 is bent to the left (toward the sensor) (tooth 101″) and somewhat larger if the saw tooth located next to the sensor 31 is bent to the right (away from the sensor) (tooth 101′). In the case of a straight tooth 101, the distance a is an intermediate value.

FIG. 7, diagram (a), shows by way of example a signal profile (waveform) of the sensor signal (measurement data) of the inductive sensor from FIGS. 3 and 4 and the detection of broken saw teeth based thereon. The sensor signal represents the distance d (see FIG. 4). At a constant cutting speed v_{c} of the saw band, the sensor signal is essentially periodic, wherein the period duration is p/v_{c} and the frequency v_{c}/p (p denotes the pitch as mentioned). For example, a band speed of 1.5 m/s and a pitch of 1.5 mm results in a sensor signal frequency of 1 kHz. Each period can thus be assigned to a saw tooth or its tooth tip. If the tooth pitch is variable, the period will also vary (e.g., vary about a mean value).

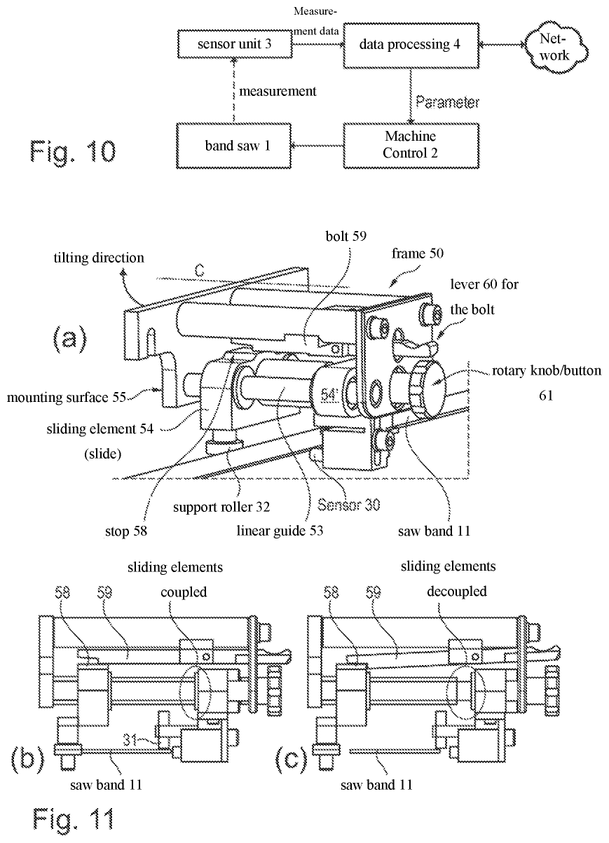

As can be clearly seen in FIG. 7, diagram (a), the local minimum in each period represents the distance between the sensor 30 and the associated saw tooth. Undamaged (unworn) and defective (broken) saw teeth can be detected by evaluating the sensor signal or the measurement data (cf. FIG. 10, data processing unit 4), for example by means of a comparison with a threshold value. If the level of the sensor signal falls below the (predefined) threshold value in a specific period (corresponds to a specific saw tooth), the respective saw tooth is detected as “not defective”. If the threshold value is not undershot, the respective saw tooth is detected as “defective”. In this way, the number of defective saw teeth and thus the state of wear of the saw band can also be determined for the saw band. The number of defective saw teeth can be a quantitative measure of the state of wear. In the example shown in FIG. 7, diagram (a), two threshold values are shown. The threshold value denoted by “tooth breakage” represents the distance di and serves for the detection of broken saw teeth. The threshold value denoted by “wear” serves for the detection of partially worn (but not broken) teeth. In a specific example, several different threshold values are used (between d₀ and d₁) representing different degrees of wear. In some examples, the wear is quantitatively evaluated directly via the measured value (in the interval between d₀ and d₁). Such evaluations, threshold value comparisons and the like can be carried out in an evaluation unit (data processing unit, cf. FIG. 10).

With the concept described here, it is not only possible to determine the number of broken saw teeth, but also the extent of wear. In some exemplary embodiments, several threshold values can be used to detect the extent of wear. The threshold value used for the detection of broken teeth may also depend on a mean value of the distances do measured (for each tooth). As described above, the value do represents the tooth height of each saw tooth. The change in the mean value of the tooth heights (in comparison to a new, unworn saw band) can be regarded as a measure of the (gradual) wear. Depending on the state of wear (reduction of the mean tooth height and/or number of broken teeth), certain process parameters (e.g. cutting speed or feed rate) can be adapted in the machine control. Depending on the current state of wear, the machine control can also decide whether a new sawing process (which can also take several hours) can be started with the saw band or whether a change of the saw band is necessary.

The detection of the interleaving of the saw band can be carried out in a similar manner to the detection of broken teeth. Assuming a straight tooth 101 has a distance a=a₀ from the sensor 31, a tooth 101′ bent to the right has a distance a₁>a₀ and a tooth 101″ bent to the left has a distance a₂<a₀. For example, two different thresholds b₁ (with a₁>b₁>a₀) and b₂ (with a₂<b₂<a₀) can be used to distinguish bent teeth from straight teeth. If the condition a>b₁ is met, then the respective saw tooth is bent to the right. If the condition a>b₂ is met, then the respective saw tooth is bent to the left. If no interleaving is detected (b₂<a<b₁), then it is also very likely to be a saw band with hard metal cutting edges, since saw bands with cutting edges of high-speed steel almost always have a setting. This information can be used by the machine control at least for a plausibility check. Furthermore, it is not only possible to detect whether a setting is present, but in some exemplary embodiments it is also possible to detect what type of setting is present (group setting, standard setting, etc., cf. FIG. 5).

FIG. 7, diagram (b), shows the detection of a sequence of different types of teeth (saw teeth of different geometry) of a non-set saw band with the aid of the sensor 31 (cf. FIG. 6). For this purpose, the sensor 31 detects the corners of the saw teeth from the side, and different types of teeth can be distinguished on the basis of the sensor signal of the sensor 31. In the case of saw teeth with a narrow main cutting edge and a long secondary cutting edge, the sensor 31 will measure a greater distance than in the case of saw teeth with a wide main cutting edge and a short (or missing) secondary cutting edge. In the case illustrated in diagram (b) of FIG. 7, it is even possible to distinguish five different types of teeth, the sequence of which is repeated periodically. For example, multiple threshold values can be used to distinguish different types of teeth. In an exemplary embodiment, the measured sequence of the amplitudes of the local minima (each local minimum corresponds to a tooth) is compared with patterns stored in a database and assigned to a specific type of saw band. Depending on the detected tooth types, the detected sequence of tooth types or the type of saw band derived therefrom, a process parameter can be adapted in the machine control (e.g. the cutting speed).

FIG. 8 illustrates an exemplary embodiment of a further measurement setup which can be combined with the example of FIG. 3, 4 or 6. Both measuring setups can be integrated one behind the other (with respect to the direction of travel of the saw band) in the same sensor device/sensor unit. Depending on the application, the two measuring setups of FIGS. 6 and 8 can also be installed separately at different points of the band saw. According to FIG. 8, the measuring setup has at least one capacitive sensor 41 (in the example shown, there are two capacitive sensors 40 and 41). The sensors 40, 41 each have two mutually opposite electrodes 40a, 40b (sensor 40) and 41a and 41b (sensor 41), the saw band extending between two electrodes 41a, 41b (and 40a, 40b).

The mode of operation of capacitive sensors for measuring the thickness of an electrically conductive material which is arranged between two electrodes (e.g. 41a and 41b) belonging to one another is known per se and is therefore not explained in more detail here. The sensor 40 serves to measure the thickness of the saw blade in the region of the back of the band and the sensor 41 serves to measure the thickness of the saw blade in the region of the secondary cutting edges of the saw teeth. The width t₁ of the cutting channel can thus be determined automatically from the sensor signal of the capacitive sensor 41.

FIG. 9 shows, by way of example, a possibility of integrating the measuring setup of FIGS. 3 and 4 into a sensor device (a sensor module) which can be mounted, for example, on the sawing frame (on the housing of the saw machine 1). According to FIG. 9, the sensor device has a frame 50 with a mounting surface 55 on which the device can be mounted on the saw machine 1 in the vicinity of the saw band (cf. FIG. 1, mounting positions 20 and 21). The frame 50 can be any desired support element, a structure of a plurality of support elements or also part of a housing. It is used for mounting or suspending various other components of the sensor device. The frame 50 has one or more linear guides on which the support roller 32 and the sensors 30 and 31 are displaceably mounted (bearing points 51).

The position of the sensors 30 and 31 is fixed after an initial adjustment. In contrast, the support roller 32 is mounted displaceably against the spring force of the spring 52. The spring 52 presses the support roller 32 against the back of the band of the saw band (cf. FIGS. 3 and 4). It is understood that FIG. 9 is merely an example and the actual construction of the sensor device depends greatly on the conditions in the respective band saw machine.

FIG. 10 is a flow chart for illustrating the coupling of the sensor device according to FIG. 9 with the machine control of the band saw. The overall system comprises the band saw 1 with a saw band 11 (cf. FIG. 1) and a measuring device (sensor unit or sensor module 3) integrated into the band saw, as well as a data processing unit 4 and the mentioned machine control 2. The machine control 2 is designed to control the operation of the band saw 1, for which purpose one or more parameters stored in the machine control 2 are used which, inter alia, characterize the saw band (saw band parameters) or depend on properties of the saw band (process parameters, such as, for example, the rotational speed of the band or the feed speed of the workpiece during the sawing process). The data processing unit 4 (evaluation unit) is designed to determine at least one value of a saw band parameter and/or one value of a process parameter based on the measurement data supplied by the sensor unit 3. The machine control 2 is further designed to receive, store, update, if necessary, already stored values, the parameter value (or several parameter values) determined with the aid of the measuring device and to use it as a saw band parameter or process parameter.

Examples of saw band parameters are, as mentioned, the number of saw teeth of the saw band (e.g. teeth per inch), the number of broken saw teeth of the saw band, the extent of wear of the saw teeth, a value which indicates whether the saw band 11 has a setting (possibly also the type of setting) or a value which represents the width of the cutting channel and/or a detected sequence of tooth types (in the case of trapezoidal teeth) or a saw band type derived therefrom. Examples of process parameters derived from the measurement data (or a saw tooth parameter determined therefrom) are the rotational speed of the band (which can also be zero in the case of an emergency shutdown of the band saw) and, depending on the sawing process, the feed speed of the workpiece.

The data processing unit 4 receives the (digital or analog) measurement data from the sensor unit 3 and is designed to process (evaluate) the sensor data in order to determine one or more saw band and/or process parameters (e.g. a parameter set) therefrom and to transfer this to the machine control 2. The data exchange between the data processing unit 4 and the machine control 2 can be effected by means of known techniques (e.g. a bus system for serial digital communication) and is generally dependent on the manufacturer of the band saw. The data processing unit 4 can thus operate independently of the machine control 2. Only the communication connection between data processing unit 4 and machine control 2 is manufacturer-specific. In a specific example, the data processing unit 4 can be integrated into the sensor unit 3 (“intelligent sensor”).

As can be seen from FIG. 10, the band saw, sensor unit, data processing unit and machine control can be operated as a control loop. This means that the data processing unit 4 can actively intervene in an ongoing sawing process based on the measurement data supplied by the sensor unit 3, for example by transmitting an updated set of parameters to the machine control 2 or by transmitting to the machine control a command which, for example, causes a change in a saw band or process parameter (during operation) or an emergency shutdown of the band saw. In addition, the measurement results or the parameters derived therefrom can be visualized by means of the HMI of the machine control 2. The HMI also enables manual intervention in the sawing process by an operator.

The data processing unit 4 additionally permits (optional) vertical integration into automation networks (cf. FIG. 10). This allows the system data to be used to optimize processes in the process management level (e.g. Supervisory Control and Data Acquisition, SCADA, systems). In addition, a cloud connection is possible. Due to the system architecture (data processing unit 2 is separate from the machine control 2), it is also possible to integrate machines with controls of older generations into an automation network.

The data processing unit 4 can have a processor and a memory for storing software instructions which, when executed by the processor, cause the data processing unit 4 to carry out the functions described here for evaluating the sensor signals/measurement data. For this purpose, the data processing unit 4 has peripheral devices (e.g. communication interfaces, analog-to-digital converters, etc.) in order to enable a connection to the sensor unit 3 and the machine control 4. The data processing unit 4 can be, for example, a personal computer (PC), an industrial PC or an embedded system. Parts of the data processing unit 4 can also be implemented by means of electronic circuits (hardware) which do not require any software for operation. A data processing unit 4 is understood to mean each entity comprising hardware and software which is suitable for providing the functions described here (for example evaluation of the sensor signals/measurement data and, based on this, the determination of one or more parameters or commands for the machine control).

FIG. 11 shows—similar to FIG. 9, a further example of the integration of the measurement setup of FIGS. 3, 4 and 6 into a sensor device. Diagram (a) of FIG. 11 shows a perspective representation and diagram (b) shows the corresponding side view. Diagram (c) of FIG. 11 shows the device with decoupled sliding elements, which will be discussed in more detail later. The example of FIG. 11 differs from the example of FIG. 9 essentially by those elements which serve to move the sensor device mounted on the band saw away from the saw band by means of a pivoting movement in order to be able to change the saw band without problems. The axis of rotation of the aforementioned pivoting movement is designated “C” in FIG. 11.

During operation, the support roller 32 is pressed against the back of the band of the saw band 11, for example by a spring (not shown in FIG. 11). In order to be able to pivot the sensor device (i.e. the housing or the frame 50) away from the saw band 11, a locking mechanism is provided which makes it possible to lock the support roller 32 at a specific distance from the band back. As in FIG. 9, the support roller 32 is also mounted in the present example on a sliding element 54 which is mounted displaceably along the linear guide 53 (part of the frame 50). The sliding element 54 has a stop 58 on which a bolt 59 can engage. In the example shown, the sliding element 54 (sliding slide) can be pressed away from the back of the band against the force of the spring until the bolt 59 engages the stop 58 and locks the sliding element 54. This state is shown in diagram (c) of FIG. 11, the spring pressing the stop 58 of the sliding element 54 against the bolt 59. The locking can be released manually by actuating the lever 60, as a result of which the bolt 59 is tilted away from the stop 59. It is understood that the illustrated locking mechanism for the support roller 32 (i.e. for the sliding element 54 on which the support roller 32 is mounted) is only one example. Other locking possibilities can also be used.

The sensors 30 and 31 are displaceably mounted on the linear guide on the second sliding element 54′. During operation, the sliding element 54′ can be clamped to the linear guide. In the illustrated case, the clamping can be activated and released via the rotary knob 61. When the clamping is released, the sliding element 54′ can be displaced in such a way that the sensors 30 and 31 are moved away from the saw teeth, as shown in diagram (c) of FIG. 11. The sensor device can then be easily pivoted away from the saw blade (about the axis of rotation C). In the state shown in diagram (b) of FIG. 11, the two sliding elements 54 and 54′ are coupled, i.e. arranged at a defined distance from one another. This distance can be predetermined, for example, by a spacer between the two sliding elements 54 and 54′.

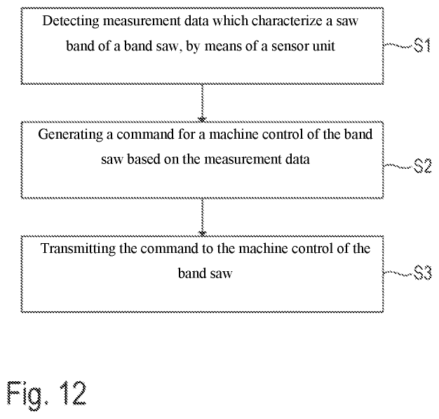

FIG. 12 shows an example of a method carried out with the aid of the system of FIG. 10 by means of a flowchart. The method accordingly comprises the detection of measurement data which characterize a saw band of a band saw by means of a sensor unit which can be integrated into the band saw (FIG. 12, step S1). The method further comprises the generation of a command for a machine control of the band saw based on the measurement data (FIG. 12, step S2) and the transmission of the command to the machine control of the band saw (FIG. 12, step S3). The command can be an update command for updating one or more saw band or process parameters. The command can also be an emergency stop command to stop the sawing process.

In an example, the generation of the command comprises the determination of at least one saw band parameter, which characterizes a property of the saw band, based on the measurement data. In this case, the command is an update command for updating the saw band parameter in the machine control. The command can also be an emergency stop command, e.g. if the saw band parameter indicates excessive wear of the saw band. Examples of saw band parameters are, as already mentioned, wear (reduction of tooth height due to wear), the width of the cutting channel, the number of teeth broken out in total, the number of consecutive teeth that are broken, setting, etc. In the event of excessive wear, e.g. when a certain number of adjacent teeth has broken out, an emergency stop command can be generated in order to terminate the sawing process.

The generation of the command can also comprise the determination (based on the measurement data) of a process parameter which influences the sawing process carried out with the band saw. In this case, the command is also an update command for updating the process parameter in the machine control (2). Examples of process parameters are, as already mentioned, the feed rate of the workpiece and the band circulation rate. These can be reduced, for example, as a function of the wear of the saw band.

The transmission of the command to the machine control can take place in particular during an ongoing sawing process carried out with the aid of the band saw in order to actively intervene in the sawing process in order to change or stop it.

1-24. (canceled)

25. A measuring device for characterizing a saw band of a band saw, the measuring device comprising:
a first inductive distance sensor configured to generate a sensor signal representing a distance between a sensor position and a front side of the saw band where saw teeth are located;
a support roller; and
a preload mechanism configured to press the support roller against a rear side of the saw band.

26. The measuring device of claim 25, further comprising:
a frame configured to mount the measuring device on the band saw,
wherein the first distance sensor is mounted on the frame (50), so that a measuring direction of the first inductive distance sensor lies in a band plane of the saw band,
wherein the support roller is slidably mounted on the frame, and
wherein the preload mechanism comprises a spring configured to generate a preload force between the frame and the support roller so that the preload force presses the support roller against the rear side of the saw band.

27. The measuring device of claim 25, further comprising:
an evaluation device configured to detect, based on the sensor signal and for each saw tooth of the saw band, whether a height of the respective saw tooth falls below a threshold value.

28. The measuring device of claim 27, wherein the evaluation device is further configured to evaluate a saw tooth as defective if the height of the respective saw tooth falls below the threshold value.

29. The measuring device of claim 27, wherein the evaluation device is further configured to count the saw teeth of the saw band evaluated as defective and/or to determine a value representing the number of saw teeth per unit length.

30. The measuring device of claim 27, wherein the evaluation device is further configured to determine a value which represents wear extent of the saw band.

31. The measuring device of claim 30, wherein the wear extent of the saw band depends on a mean value of the measured heights of the saw teeth.

32. The measuring device of claim 25, further comprising:
a second inductive distance sensor configured to generate a second sensor signal indicating whether the saw teeth lie in a band plane of the saw band or are oblique to the band plane.

33. The measuring device of claim 25, further comprising:
a further sensor configured to measure a value representing a width of a cutting channel of the saw band.

34. The measuring device of claim 25, wherein the support roller is mounted on a displaceable sliding element, and wherein the measuring device has a locking mechanism configured to block the preload mechanism and hold the support roller in a position which is spaced from the rear side of the saw band.

35. The measuring device of claim 25, wherein the first inductive distance sensor is mounted on a further displaceable sliding element, and wherein the further displaceable sliding element is fixable by a clamping mechanism.

36. The measuring device of claim 25, wherein the support roller is arranged opposite the first inductive distance sensor.

37. The measuring device of claim 25, wherein the first inductive distance sensor is arranged in a band plane of the saw band.

38. A system, comprising:
a band saw with a saw band and a machine control, the machine control configured to control a sawing process carried out by the band saw, one or more saw band parameters and/or process parameters being stored in the machine control and which are used for controlling the sawing process;
a measuring device configured to determine at least one parameter value characterizing the saw band,
wherein the measuring device comprises a first inductive distance sensor configured to generate a sensor signal that represents a distance between a sensor position and a front side of the saw band where saw teeth are located, a support roller, and a preload mechanism configured to press the support roller against a rear side of the saw band,
wherein the machine control is further configured to receive the parameter value determined with the aid of the measuring device, or a parameter value derived therefrom, and to store the parameter value as a saw band parameter or process parameter.

39. The system of claim 38, wherein the at least one parameter value characterizing the saw band comprises one of the following values:
a value representing the number of saw teeth of the saw band;
a value representing the number of broken saw teeth of the saw band;
a value indicating whether the saw band has a setting;
a value representing a width of a cutting channel of the saw band.

40. The system of claim 38, wherein the measuring device is connected to the band saw such that the measuring device is pivotable relative to the saw band.

41. The system of claim 38, wherein the measuring device comprises a sensor integrated into the band saw and a data processing unit, wherein the sensor is configured to supply measurement data characterizing the saw band, and wherein the data processing unit is configured to determine the parameter value from the measurement data.

42. The system of claim 41, wherein the data processing unit is further configured to determine a process parameter relating to the sawing process carried out by the band saw from the parameter value.

43. The system of claim 42, wherein the data processing unit is further configured to update the process parameter based on the measurement data and to transmit the parameter to the machine control.

44. The system of claim 41, wherein the data processing unit is further configured to update the at least one parameter based on the measurement data and to transmit the parameter to the machine control.

45. A method, comprising:
detecting, by a first inductive distance sensor, a distance between a sensor position and a front side of a saw band of a band saw where saw teeth are located, while a support roller presses against a rear side of the saw band;
generating a command for a machine control of the band saw based on the measurement data; and
transmitting the command to the machine control of the band saw.

46. The method of claim 45, wherein generating the command comprises:
determining at least one saw band parameter characterizing a property of the saw band based on the measurement data,
wherein the command is a command for updating the at least one saw band parameter in the machine control.

47. The method of claim 45, wherein generating the command comprises:
determining a process parameter that influences a sawing process performed with the band saw based on the measurement data,
wherein the command is a command for updating the process parameter in the machine control.

48. The method of claim 47, wherein the process parameter update in the machine control causes the sawing process to be interrupted.

49. The method of claim 45, wherein the command is transmitted to the machine control during a running sawing process carried out with the aid of the band saw to change or stop the running sawing process.

50. A system, comprising:
a band saw;
a machine control for the band saw;
a sensor unit integrated into the band saw and configured to detect measurement data characterizing a saw band of the band saw; and
a data processing unit comprising a processor and memory storing instructions which, when executed by the processor, cause the system to generate a command for the machine control based on the measurement data and transmit the command to the machine control.
